(19) United States
(12) Patent Application Publication
(10) Pub. No.: US 2006/0285927 A1
(43) Pub. Date: Dec. 21, 2006

(54) SUBTERRANEAN STORAGE VESSELS AND INSTALLATION THEREOF

(75) Inventors: Graeme F. Hisgrove, Brighton (AU); David Alan Beattie, Beaconsfield (AU); Luke A. Troja, Prahran (AU); Desmond John Berry, Mount Eliza (AU)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Linpac Rotational Mouldings Pty. Ltd., Carrum Downs (AU)

(21) Appl. No.: 11/424,108

(22) Filed: Jun. 14, 2006

(30) Foreign Application Priority Data
Jun. 15, 2005 (AU) 2005903118
Jul. 4, 2005 (AU) 2005903520
Feb. 16, 2006 (AU) 2006900768

(51) Int. Cl. B65G 5/00

(52) U.S. Cl. 405/53; 220/23.91

(57) ABSTRACT

An underground water storage vessel includes a generally toroidal-shaped hollow body of rotationally moulded plastics with an upright turret having an access port therein. Formed on the outer surface of the hollow body are solid reinforcing ribs in a mesh-like pattern wherein the intersections between the ribs are integrally formed. The underground water storage vessels are installed in reactive soils with a cast concrete ballast extending from an upper region of the vessel via an aperture therein to an interface with a substantially incompressible material, the interface being located intermediate upper and lower regions of the vessel.

### CROSS-REFERENCE TO RELATED APPLICATIONS

This application claims priority to Australian Patent Application Nos. 2005903118, filed Jun. 15, 2005, 2005903520, filed Jul. 4, 2005, and 2006900768, filed Feb. 16, 2006, the contents of which are incorporated herein by specific reference.

### BACKGROUND OF THE INVENTION

1. The Field of the Invention

This invention is concerned with storage vessels for liquids. The invention is concerned particularly although not exclusively with underground water storage vessels.

2. The Relevant Technology

In arid and semi-arid regions of Australia and elsewhere in the world, there is a growing awareness of the need to conserve water as the possible effects of global warming or other long term cyclic weather patterns manifest themselves in long term drought. Even urban areas are not immune from water shortages as reduced rainfall in storage catchment areas leads to increasingly restrictive regulation of water usage.

In an endeavour to reduce the dependence of individual households on rapidly dwindling urban water storage facilities, householders are encouraged to collect rainwater run off from rooves and/or grey water from waste water conduits coupled to sewerage pipes. In some regions the sense of urgency in sustainable domestic water usage practices is so great that local council authorities are offering cash rebates and other incentives for homeowners to install rainwater and/or grey water storage tanks.

A difficulty with above ground storage tanks is that they are aesthetically unappealing with a choice restricted to upright cylindrical vessels with smooth or ribbed walls or slab sided rectangular tanks. Cylindrical tanks are structurally better suited to containment of fluid pressures and thus rectangular tanks generally have limited storage capacity in a domestic application.

Above ground tanks are better suited to rainwater storage as they are located below the roof surface from which water is collected. Grey water is difficult to collect gravitationally as the upper level of the tank must be located below the lowest collection point of a waste water conduit system. Unless a domestic dwelling is located on a large steeply sloping plot of land, this usually necessitates burial of the grey water tank to enable grey water collection by gravity alone.

Generally speaking, most conventional storage tanks suitable for above ground collection of rainwater or grey water are selected from cylindrical concrete, galvanized or corrosion proofed steel sheet or rotationally moulded polyethylene. Of these, only concrete tanks are suited for underground burial as they are both corrosion resistant and capable of withstanding substantial earth pressure and vehicular loadings. Although steel sheet tanks and rotationally moulded polyethylene tanks can be constructed to withstand greater earth pressure and vehicular loadings, this is at the expense of reinforced structures with greater wall thicknesses and substantially greater cost.

A problem with concrete storage tanks is that their cylindrical structure either requires a deep narrow diameter excavation for an upright orientation or a large rectangular excavation, albeit less deep for a horizontal orientation. Either way, the substantial mass of a concrete tank necessitates the use of a crane to locate the tank in an excavation.

Storage tanks constructed from steel sheet are unsuited to underground locations as they are prone to corrosion, particularly from corrosive elements in the ground water.

Conventional cylindrical rotationally moulded polyethylene storage tanks are particularly resistant to corrosion however their low mass and poor resistance to compressive loads makes them unsuitable for use as underground tanks as they can “float” out of the ground due to buoyancy in the presence of high ground water levels when empty or nearly empty and they have low resistance to vehicular and/or earth pressures.

In terms of structural efficiency, a spherical vessel is the most efficient in terms of resistance to internal and external pressures. From a practical viewpoint however, spherical vessels have spatial disadvantages in the manufacture, transportation and underground installation of such vessels. Depending upon the material from which a storage tank is made, the overall configuration is generally a compromise between a most efficient spherical configuration and a generally cylindrical tank utilizing a circular cross-section section to maximize hoop stress values at least. Whether concrete, steel sheet, fibreglass or rotationally moulded thermoplastics polymers are used, the properties of those materials will have a profound bearing upon the relative length/diameter ratio of a cylindrical tank as well as reinforcing features which may be dependent upon whether the cylindrical axis is oriented vertically or horizontally.

Generally speaking, because of cost constraints liquid storage tanks for rainwater or grey water storage are limited to fairly simple cylindrical shapes.

U.S. Pat. Nos. 6,227,396 and 6,491,054 describe a generally cylindrical rotationally moulded polyethylene liquid storage tank intended for subterranean location. To withstand externally applied earth pressures, the side wall of the tank is formed with an alternating pattern of circular and octagonally shaped ribs and the end walls are formed with upright ribs and end plates to enable modular coupling of adjacent tanks. To resist ground pressure between opposite ends of the tanks lying with a horizontal cylindrical axis, internal spreader members extend between internally opposed end wall faces. This structure is claimed to best equate to the theoretically most pressure efficient spherical shape.

United States Patent Publication US 2004/0188447 A1 describes a generally cylindrical underground storage tank having a horizontal cylindrical axis. The tank body is comprised of rotationally moulded polyethylene and is reinforced to resist deformation from groundwater buoyancy loads and reactive soil loads by the provision of spaced pockets in the side walls of the tank body. In one embodiment the upper and lower walls of the pockets are connected by an open tubular column formed integrally with the thank body by a well-known process of using “kiss throughs” in the moulding process. The open columns are said to permit ground water to pass therethrough in either direction and can be moulded to have a frusto-conical tapered inner wall or an hourglass shape with the inner wall tapering to a waist intermediate the upper and lower openings.

In installation, the tank may be anchored in the ground by anchor members secured to anchoring lugs to resist the buoyancy forces of surrounding groundwater. The reinforcing pockets gain further external support by the provision of earth fill or “adding masonry support into the receiving pockets 38” whereby the hollow columns also receive masonry support.

The structure of US Patent Application US 2004/0188447 appears to be similar to Nu Con Sept (Trade Mark) septic tanks available from Snyder Industries Inc., of Nebraska, United States of America in the provision of open tubular reinforcing members extending within the hollow body and between upper and lower regions thereof.

Other commercially available underground septic tanks or cisterns are manufactured by Norwesco of Minnesota, United States of America. These tanks also include hollow tubular columns, open at the top and the bottom, extending between an upper wall and the floor of the tank to provide support for vertical loads, particularly when filled with a compression resistance fill material.

Toroidal storage tanks for liquefied petroleum gas in motor vehicles are described in European Publication Nos. EP 0969243, EP 0969242, EP 1378390 and EP 12191221.

Other uses of toroidally shaped fuel tanks in aircraft and space vehicles are described in U.S. Pat. Nos. 4,667,907 and 4,615,542 and European Publication No EP 1038120.

International Publication No WO 01/23682 A1 describes a torus-shaped rotationally moulded plastic tank suitable for use as an underground septic tank. This tank includes a number of radially oriented circumferential “hollow” reinforcing ribs that extend inwardly from the outer surface of the tank body to form recessed grooves or channels and a plurality of spaced anchoring lugs to anchor the tank in an excavation via cables and pegs or other earth anchors.

German Patent No DE 100 52 324 and German Utility Model No DE 20018080U1 both describe a partially rectangular-shaped underground tank comprising four cylindrical side portions joined at each corner by a 90° elbow to form a vessel having a large cavity between the side portions of the rectangular body. The structure is reinforced by spaced parallel “hollow” circumferential ribs on the cylindrical portions and radially oriented spaced circumferential “hollow” ribs on each 90° corner elbow. The ribs extend outwardly from the outer surface of the tank body whereby corresponding hollow channel-like recesses are formed on the inner surface of the tank body. These tanks are installed in an excavation on a layer of pea gravel/sand mixture with round river pebbles of 50-75 mm in diameter located within the central cavity to allow groundwater to rise and fall relatively unimpeded.

It is an aim of the present invention to provide an underground liquid storage vessel which overcomes or ameliorates at least some of the disadvantages associated with prior art underground liquid storage tanks.

### SUMMARY OF INVENTION

According to one aspect of the invention there is provided a liquid storage vessel adapted for subterranean installation, said vessel comprising:

a hollow moulded plastics body having at least one aperture extending between upper and lower walls of said vessel, said body including a plurality of solid intersecting reinforcing ribs extending outwardly from an outer surface thereof, said body further including at least one access port.

Preferably, said body has a substantially toroidal configuration.

Suitably, said body includes a plurality of laterally extending axially spaced reinforcing ribs extending about said body.

If required, said body includes a plurality of upright spaced circumferential ribs extending away from a centre of a substantially circular cross-sectional region of said body.

Preferably, said laterally extending ribs and said upright ribs are integrally formed at intersections therebetween to form a mesh-like reinforcing structure.

The hollow body may have a substantially circular configuration in a plane orthogonal to said central toroid axis.

If required, the hollow body may have a substantially oval configuration in a plane orthogonal to said central toroid axis.

The hollow body may include at least one sump member adapted, in use, to locate a submersible pump.

Preferably, said at least one access port is located adjacent and above said at least one sump member.

If required, said at least one access port may be comprise an access turret communicating with the interior of said body.

Suitably, said storage vessel is adapted for fluidic coupling to an adjacent storage vessel via a conduit extending between apertures in respective base portions of adjacent vessels.

According to another aspect of the invention there is provided a method for installation of the aforementioned subterranean water storage vessels, said method comprising the steps of:

forming an excavation in an earth mass to a desired depth;

forming a base surface in said excavation;

locating said storage vessel within said excavation; and,

introducing into said at least one aperture substantially incompressible material to form a support pier or column extending between said upper and lower walls of said vessel.

Suitably, such vessel is at least partially encased in said substantially incompressible material.

If required, said substantially incompressible material may comprise a cementitious material.

Said substantially incompressible material may comprise steel reinforced concrete.

Alternatively, such substantially incompressible materials may comprise a particulate aggregate.

Preferably, said vessel, in use, is supported, in a lower region of said at least one aperture and about the base and sides of said vessel, by particulate aggregate and in an upper region by a ballast of settable cementitious material extending from an upper region of said vessel via an upper region of said at least one aperture to an interface with particulate aggregate located in said lower region of said at least one aperture whereby said vessel is substantially encapsulated by incompressible material.

Suitable, outwardly extending rib members formed on an outer surface of said vessel are substantially encapsulated by said incompressible material to resist buckling of said ribs under load.

### BRIEF DESCRIPTION OF THE DRAWINGS

In order that the invention may be readily understood and put into practical effect, exemplary embodiments will now be described in the accompanying drawings in which:

FIG. 1 shows a perspective view of a circular toroidal liquid storage vessel;

FIG. 2 shows schematically a top plan view of the vessel of FIG. 1;

FIG. 3 shows a perspective view of an elongate or oval toroidal liquid storage vessel;

FIG. 4 shows schematically a top plan view of the vessel of FIG. 3;

FIGS. 5 to 8 show alternative installations according to the invention; and

FIGS. 9 to 12 show further installations according to the invention.

In the drawings, where appropriate, like reference numerals are employed for like features for the sake of simplicity.

### DETAILED DESCRIPTION OF THE PREFERRED EMBODIMENTS

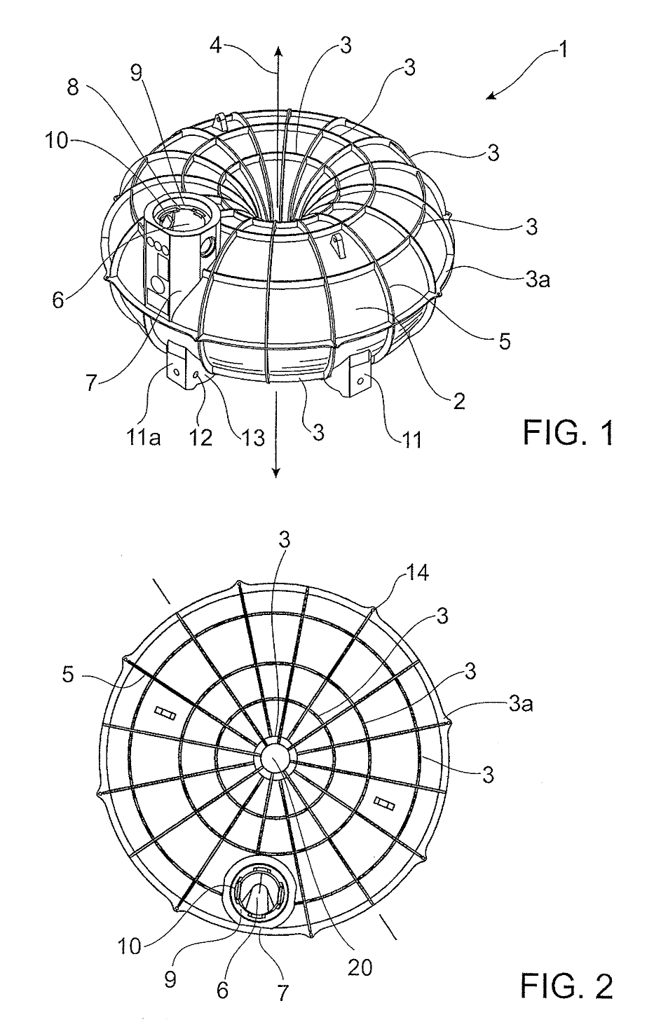

In FIG. 1 there is shown a moulded plastics liquid storage vessel 1 having a hollow generally toroidal body 2 with a plurality of solid circumferential ribs 3 spaced annularly relative to a central toroid axis 4 and a plurality of solid circumferential ribs 5 extending radially about a centre (not shown) of a generally circular cross-sectional region of the hollow interior of body 2. At the point of intersection between ribs 3 and 5, the ribs are integrally formed to form a mesh-like reinforcing structure.

Extending upwardly from an upper side of body 2 is an inlet port 6 in the form of a cylindrical turret 7 in fluid communication with the hollow interior of body 2. Located on an inner wall surface 8 of turret 7 is a shouldered abutment 9 for sealing engagement with a closure member (not shown) securable to turret 7 via a bayonet-type connection engaging in shaped slots 10.

On the lower side of body 2 are sump members 11, one of which sump members 11a being located generally below turret 7 to locate therein a submersible electric pump (not shown).

The closure member (not shown) for turret 7 includes a fitting adapted to sealingly engage with an inlet conduit for rainwater and/or grey water inlet. The closure member also includes a gland to sealingly engage an electrical conduit coupled to the submersible pump and a fitting or gland to couple with an outlet conduit coupled to the submersible pump.

An aperture 12 may be formed in a side wall 13 of a sump member 11 to enable fluidic coupling between adjacent vessels 1 in a “daisy chain” effect whereby a plurality of vessels can constitute a composite liquid storage system.

FIG. 2 is a top plan view of the storage vessel of FIG. 1.

As can be seen in FIG. 2, a central aperture 20 is formed in the body 2 whereby an earth anchor or the like (not shown) may be secured in an earth formation to prevent displacement of the vessel due to buoyancy forces although where high groundwater levels are encountered, the application of a top ballast load is preferred to anchoring as in certain conditions anchoring to a concrete base or to earth anchors can lead to deformations in the tank due to concentrated buoyancy loads in the anchoring points of the tank. Alternatively or in addition, the circumferentially outermost rib 3a may include apertures 14 to locate anchor members (not shown).

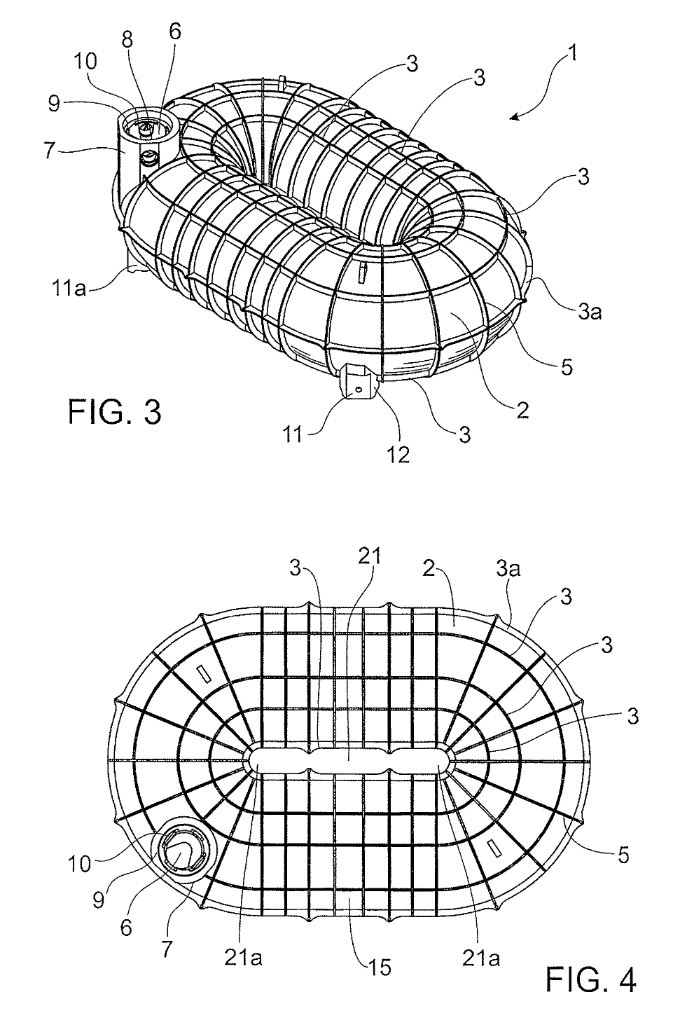

FIGS. 3 and 4 show an elongate or oval shaped “toroidal” body 2 having straight cylindrical regions 15 extending between opposed semi-toroidal portions 16 to form a liquid storage vessel of larger volumetric capacity than that shown in FIGS. 1 and 2. The structural features of the vessel of FIGS. 3 and 4 are otherwise substantially identical to those illustrated in FIGS. 1 and 2.

The vessels of FIGS. 1 and 2 and FIGS. 3 and 4 conveniently are formed by rotational moulding of a low density polyethylene (LDPE) compound in a modular mould assembly having removable inserts to form the straight cylindrical regions 15 shown in FIGS. 3 and 4.

In use, a relatively shallow excavation is made in an earth formation adjacent a dwelling structure or even in a vehicular driveway. Because of the relatively shallow excavation and relatively low mass of the storage vessel, excavations may be effected in relatively inaccessible areas by a smaller excavator and the vessel may be placed in the excavation manually without the inconvenience and expense of a boom crane or the like. Depending upon the nature of the soil structure a layer of bedding sand may be placed in the base of the excavation to facilitate levelling of the storage vessel before installation of the pump and plumbing connections prior to back filling with earth and simple compacting in stable soils. Where the vessel is located, say, beneath a vehicular driveway, the central region of the toroidal or elongate toroidal body may be filled with a relatively low strength concrete to form a central waisted pier or pillar capable of withstanding a compressive force of vehicular traffic.

In reactive earth structures such as hydraulic clays, a concrete slab may be poured in the base of the excavation or a prefabricated concrete base comprising one or more connecting elements may be located on the floor of the excavation. Tensionable steel rods or cables (not shown) connected between anchor eyes in the concrete base and the apertures 14 in the outermost rib 3a serve to anchor the vessel against “floating” upwardly. Alternatively or in addition, a screw pile having a deformed bar threaded shaft may be anchored into the earth formation via central aperture 20 of the toroidal structure of FIGS. 1 and 2 or via the opposite ends 21a of elongate central aperture 21 of elongated toroidal structure of FIGS. 3 and 4. One or more bearing plates having an aperture therein may be located over the free end or ends of the threaded shafts and are then secured in place by threaded nuts engaging on the threaded shafts.

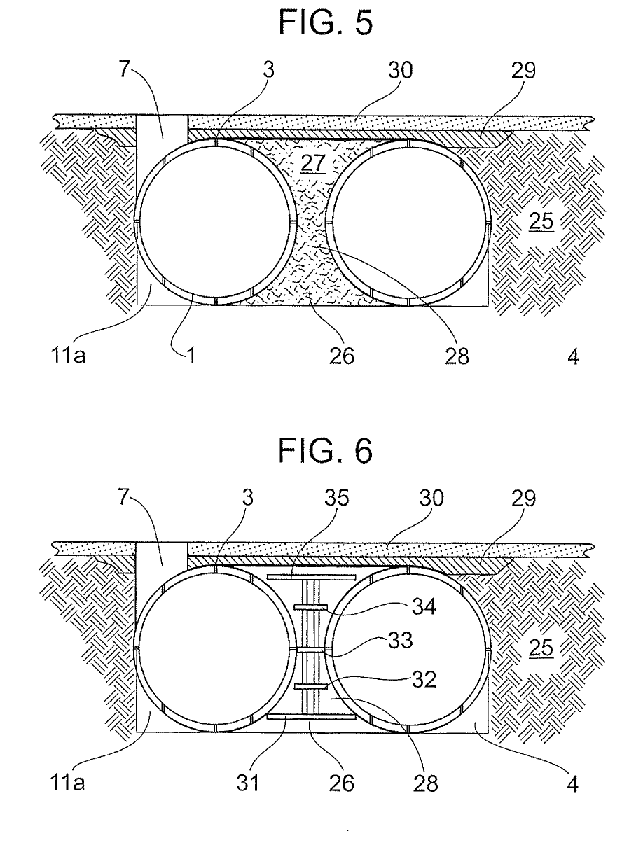

FIGS. 5 to 8 show alternative installation methods according to the invention.

In FIG. 5, the vessel 1 is first located in an excavation cavity in an earth formation and earth 25 is filled in around the outer region of the excavation and compacted. A mass of concrete 26, with or without enlarged end plastics or steel fibres, is poured into the central region 27 of the toroidal body 2 to form a central waisted pier or column 28 which may be levelled within the uppermost circular rib 3. The earth region above vessel 1 is then levelled to a predetermined depth with a layer of packing sand 29 or the like which is compacted before pouring a concrete driveway 30 or the like over the top of vessel 1 with a top surface level with the top of cylindrical turret 7.

FIG. 6 shows an adaptation of the installation illustrated in FIG. 5 in that column 28 is reinforced with a structure fabricated from steel reinforcing bars in the form of circular bands 31, 32, 33, 34, 35 and upright members 36.

For convenience, the reinforcing structures are formed in two pieces with a base portion comprising bands 31, 32 and 33 secured to one upright member 36. This portion is placed in the base of the vessel excavation prior to locating the vessel 1 thereover. A top portion comprising bands 34, 35 secured to the other upright member is then located in the central region of the toroidal structure prior to filling with concrete to form a steel reinforced waisted pier or column 28 capable of withstanding a compressive load from a vehicle or the like on driveway 30.

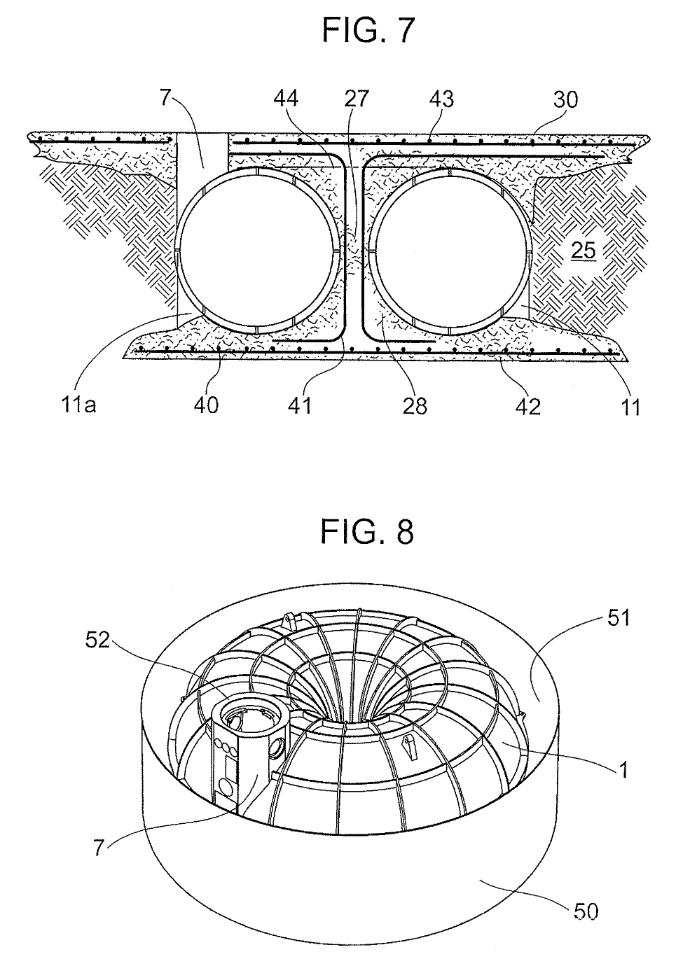

FIG. 7 shows yet another installation of the subterranean vessel according to the invention.

After excavating earth to a desired depth, the layer of reinforcing mesh 40 or the like is located in the excavation and is supported by bar chairs or the like and shaped lower starter bars 41 are supported on the mesh while a layer 42 of fresh concrete is poured. Vessel 1 is then positioned in the excavation and bedded into the wet concrete layer 42 with the upright legs of starter bars 41 extending through the central aperture 27 of vessel 1. The side regions of the excavation are then filled in with earth and compacted as desired. A layer of reinforcing mesh 43 is then supported on bar chairs (not shown) on a prepared earth surface surrounding vessel 1 and inverted bars 44 are suspended from mesh 43 with downwardly extending bars extending into the central aperture 27 where they are tied to the upright legs of starter bars 41.

A concrete driveway is then poured in a conventional manner except that a mass of concrete is introduced via the central aperture 27 of vessel 1 to fill the void in the central aperture region of vessel 1 and to extend in a layer over the top of the vessel 1. In the structure shown, the toroidal body 2 is supported on a steel reinforced concrete pad 42 with a steel reinforced waisted pier or column 28 formed integrally with the concrete pad 42 and the driveway 30.

FIG. 8 shows still a further installation method according to the invention.

In this embodiment, a circular barrier wall 50 of flexible plastics, steel or plywood is erected about vessel 1 in an excavation (not shown) with vessel 1 resting on a base of compacted bedding sand, road base material, a prefabricated concrete base or a formed in-situ concrete support pad (also not shown). A quantity of bedding sand, road base material, sand/aggregate mix is then introduced into the region 51 between vessel 1 and wall 50 as well as into the central aperture 27 and is then compacted with a vibratory compaction device to form a substantially incompressible mass surrounding vessel 1. A concrete driveway/garage floor or the like can then be formed over the top of vessel 1 up to the top level 52 of turret 7 after the excavation surrounding wall 50 has been filled in and compacted.

Alternatively, the central cavity 27 and the perimeter region 51 may be filled with a low strength concrete, with or without steel reinforcing in the region of central aperture 27 and/or over the top of the vessel 1. When the concrete has cured, at least partially, a driveway or the like may be formed thereover in a conventional manner.

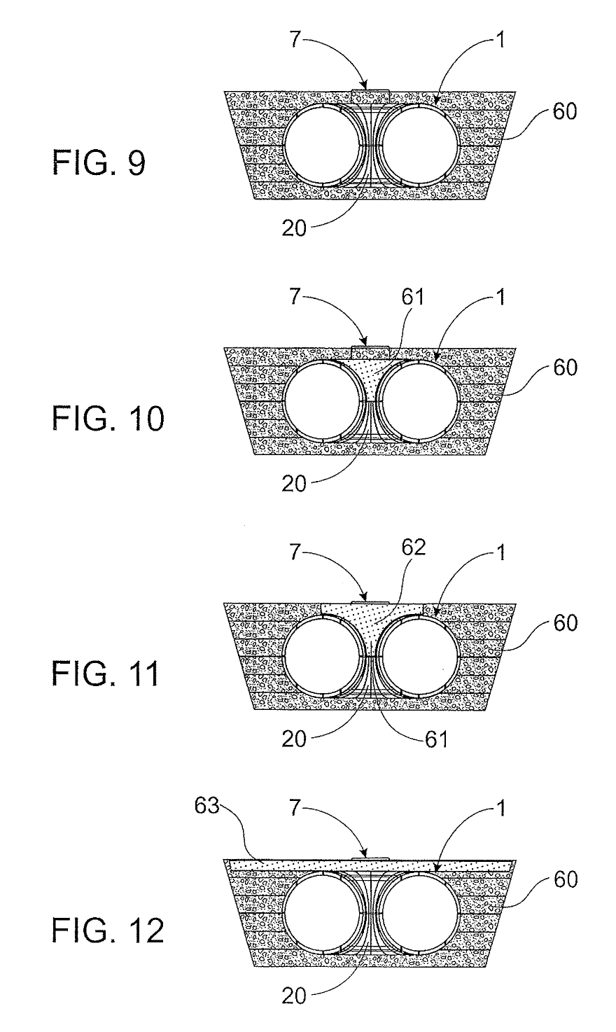

FIGS. 9 to 12 show further installation methods according to the invention.

It has been found in practice that compacted particulate aggregate such as gravel or sand/gravel mixes can provide adequate resistance to compressive loads applied to the vessels according to the invention as compacted gravel and sand/gravel mixes form a substantially incompressible mass in much the same way as a settable cementitious composition. Whether the vessels according to the invention are substantially encapsulated by a mass of compacted particulate aggregate, settable cementitious material or a combination of both, in all cases, the externally projecting solid reinforcing ribs are themselves encapsulated whereby buckling of those ribs under load is greatly resisted thus enhancing the overall resistance to compressive loads applied to the vessel by ground forces and/or vehicular loads.

FIG. 9 shows an installation in sandy soil which is largely free draining of ground water. In this type A soil the vessel 1 is completely encapsulated in compacted gravel 60.

FIG. 10 shows an installation in soil type S comprising a sandy soil with a small amount of clay. An unreinforced concrete core element 61 having a strength of 20-25 MPa occupies the upper region of the central aperture 20 and rests upon the mass of gravel 60 occupying the lower region of central aperture 20 in a manner whereby downwardly directed forces are resisted by the gravel 60 and the coaction between the concrete core element 61 and the upper portion of vessel 1. Core element 61 provides a ballast mass to resist buoyancy forces from ground water.

FIG. 11 shows an installation in soil types M and H comprising mostly clay. In this embodiment, a thicker concrete cap 62 increases the ballast mass where greater buoyancy forces from a hydraulic soil are anticipated.

FIG. 12 shows the installation of FIG. 9 having a steel reinforced driveway or pathway 63 formed over an incompressible compacted gravel encapsulating material 60.

Compared with the installations illustrated in FIGS. 5 to 8, the installation methods illustrated in FIGS. 9 to 12 are substantially simpler and less expensive yet capable of similar load bearing properties.

The toroidal vessels in accordance with the present invention may be manufactured by any suitable moulding process including rotational moulding with polyolefinic compounds, injection moulding, blow moulding or vacuum forming with polyolefinic or other thermoplastic resins or even fibre reinforced plastics (fip) moulding processes. The vessels may be made as an integral body by, say, rotational moulding or they may be fabricated in sections by other moulding processes and then joined by mechanical and/or adhesive joints. Preferably, the vessels are made by rotational moulding as a cost efficient compromise between labour and materials and structural integrity of the vessel.

Although the description of the invention has been exemplified with reference to “pure” toroidal and “stretched” toroidal structures, it is to be understood that these expressions are intended to include other configurations of storage vessel having one or more apertures extending between upper and lower walls thereof. The one or more apertures permit the construction therein of a substantially incompressible load support pier or column to resist compressive loads on the vessel. For example, the vessel may comprise a substantially rectangular vessel measuring 1.5 metres square in plan view with a depth of 1 metre. Located in the centre of the vessel is an aperture 300 mm in diameter with a contiguous cylindrical wall connected to the top and bottom walls thereof. For elongate rectangular vessels, through apertures may be spaced along a central longitudinal axis and/or on parallel axes spaced from the central axis. In all cases these “rectangular toroidal” structures comprise both upright and laterally extending solid outwardly projecting reinforcing ribs which are integrally formed at intersections therebetween.

A particular advantage of the externally ribbed toroidal structure according to the invention is that when surrounded by a substantially incompressible material such as sand, gravel, cementitious materials or combinations thereof, the solid reinforcing ribs are constrained by the intersecting solid ribs and by the incompressible encapsulating material to resist a buckling mode of failure due to externally applied earth pressures on the toroid wall thereby providing an enhanced structural reinforcing effect when compared with unsupported solid ribs, particularly non-intersecting ribs. Vessels reinforced with “hollow” reinforcing ribs comprising a projecting rib surface on one side of the vessel wall and a corresponding hollow channel on the opposite side of the vessel wall are inferior in strength to solid reinforcing ribs and do not benefit from encapsulation in substantially incompressible material. This permits even greater design optimization in terms of wall thickness, rib thickness and depth and thus cost of the vessel in terms of polymer usage.

It readily will be apparent to persons skilled in the art that many modifications and variations may be made to the invention without departing from the spirit and scope thereof.

For example, turret 7 may be extendible by a height adjustable collar and lid and/or a height adjustable riser to precisely locate an access opening at or slightly above a ground level.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A liquid storage vessel adapted for subterranean installation, said vessel comprising:
a hollow moulded plastics body having at least one aperture extending between upper and lower walls of said vessel, said body including a plurality of solid intersecting reinforcing ribs extending outwardly from an outer surface thereof, said body further including at least one access port.

2. A vessel as claimed in claim 1 wherein said body has a substantially toroidal configuration.

3. A vessel as claimed in claim 2 wherein said body includes a plurality of laterally extending axially spaced reinforcing ribs extending about said body.

4. A vessel as claimed in claim 3 wherein said body includes a plurality of upright spaced circumferential ribs extending away from a centre of a substantially circular cross-sectional region of said body.

5. A vessel as claimed in claim 4 wherein said laterally extending ribs and said upright ribs are integrally formed at intersections therebetween to form a mesh-like reinforcing structure.

6. A vessel as claimed in claim 2 wherein said hollow body has a substantially circular configuration in a plane orthogonal to a central toroid axis.

7. A vessel as claimed in claim 2 wherein said hollow body has a substantially oval configuration in a plane orthogonal to said central toroid axis.

8. A vessel as claimed in claim 1 wherein said hollow body includes at least one sump member adapted, in use, to locate a submersible pump.

9. A vessel as claimed in claim 1 wherein aid at least one access port comprises an access turret communicating with the interior of said body.

10. A vessel as claimed in claim 1 wherein said storage vessel is adapted for fluidic coupling to an adjacent storage vessel via a conduit extending between apertures in respective base portions of adjacent vessels.

11. A method for installation of water storage vessels according to claim 1, said method comprising the steps of:
forming an excavation in an earth mass to a desired depth;
forming a base surface in said excavation;
locating said storage vessel within said excavation; and,
introducing into said at least one aperture substantially incompressible material to form a support pier or column extending between said upper and lower walls of said vessel.

12. A method as claimed in claim 11 wherein said vessel is at least partially encased in said substantially incompressible material.

13. A method as claimed in claim 12 wherein said substantially incompressible material comprises a cementitious material.

14. A method as claimed in claim 13 wherein substantially incompressible material comprises steel reinforced concrete.

15. A method as claimed in claim 12 wherein said substantially incompressible materials comprises a particulate aggregate.

16. A method as claimed in claim 12 wherein said vessel, in use, is supported, in a lower region of said at least one aperture and about the base and sides of said vessel, by particulate aggregate and in an upper region by a ballast of settable cementitious material extending from an upper region of said vessel via an upper region of said at least one aperture to an interface with particulate aggregate located in said lower region of said at least one aperture whereby said vessel is substantially encapsulated by incompressible material.

17. A method as claimed in claim 16 wherein said ballast of settable cementitious material is supported over an upper surface region of said vessel to distribute, over said upper surface region, a load resistance of buoyancy forces applied to said vessel by groundwater.

18. A method as claimed in claim 16 wherein outwardly extending rib members formed on an outer surface of said vessel are substantially encapsulated by said incompressible material to resist buckling of said ribs under load.
